(19) United States
(12) Patent Application Publication
(10) Pub. No.: US 2012/0092879 A1
(43) Pub. Date: Apr. 19, 2012

(54) LAMP INCORPORATING CLIPS

(75) Inventor: CHIH-HAO CHANG, Chu-Nan (TW)

(73) Assignee: FOXSEMICON INTEGRATED TECHNOLOGY, INC., Chu-Nan (TW)

(21) Appl. No.: 13/300,633

(22) Filed: Nov. 20, 2011

Related U.S. Application Data
(66) Substitute for application No. 12/904,141, filed on Oct. 13, 2010, now abandoned.

(51) Int. Cl. F21V 21/00

(52) U.S. Cl. 362/374

(57) ABSTRACT

A lamp includes a housing, a cover mounted on the housing, a light source received between the housing and the cover and a plurality of clips fixing the housing to the cover. Each clip has two opposite ends pressing against a top face of the housing and a bottom face of the cover, respectively, and a middle bent inwardly towards the housing. The housing includes a top wall having a plurality of slots to receive corresponding ends of the clips and a sidewall extending downwardly from the top wall to be pressed by the middles of the clips. The cover includes a bottom plate and a flange extending upwardly from the bottom plate. The flange defines a plurality of depressions adjacent to the bottom plate to receive the other ends of the clips.

### BACKGROUND

1. Technical Field

The present disclosure relates to a lamp, and more particularly, to a lamp incorporating clips.

2. Description of Related Art

A conventional lamp generally includes a housing, a cover fixed to the housing and a light source received between the housing and the cover. The cover is usually fixed to the housing by screws. Nevertheless, using the screws to fix the cover and the housing is inconvenient and time-waste, requiring corresponding tools (such as screwdriver) for manipulation thereof. Therefore, a new type clip is introduced to substitute the conventional screws used in the lamp. By resiliently sandwiching the housing and the cover between two opposite ends of the clips, the cover can be conveniently secured to the housing without tools, thereby facilitating assembly of the lamp.

However, as sandwiching the housing and the cover between the two ends thereof, the clip is subject to a concentrated stress on a middle thereof due to resilient deformation. The concentrated stress acting on the middle of the clip is prone to damage the clip that the clip may fracture from the middle thereof, raising the risk that the cover falls from the housing.

What is needed, therefore, is a lamp incorporating clips which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exemplary view of a lamp of the present disclosure.

FIG. 2 is an inverted view of the lamp of FIG. 1.

FIG. 3 is an exploded view of the lamp of FIG. 1, after the lamp of FIG. 1 is rotated horizontally for 180 degrees.

FIG. 4 is an exploded view of the lamp of FIG. 2.

FIG. 5 shows a side of a clip of the lamp of FIG. 4.

### DETAILED DESCRIPTION OF THE EMBODIMENTS

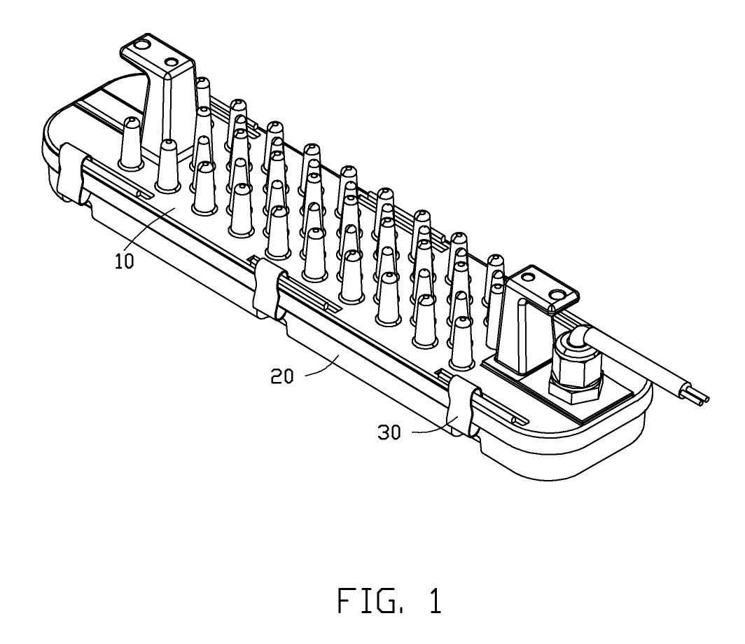

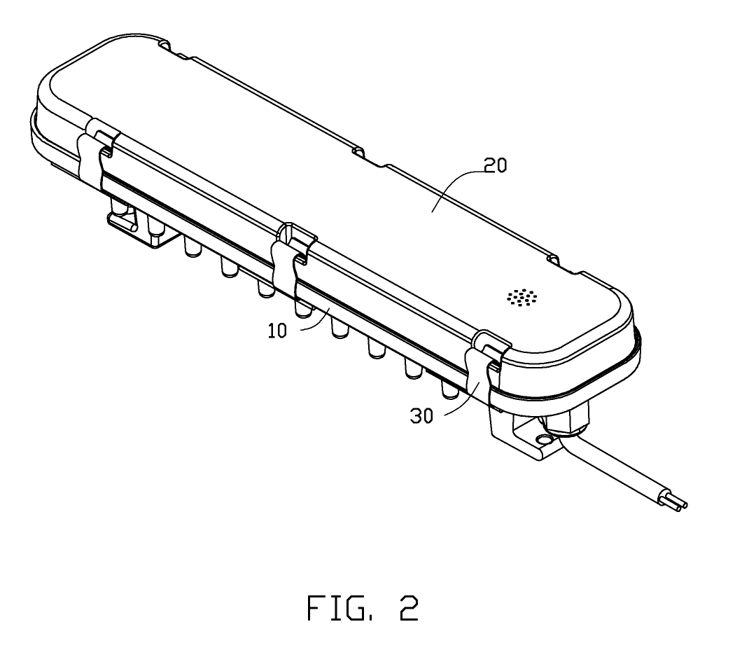

Referring to FIGS. 1-2 and 4, a lamp of the present disclosure is disclosed. The lamp includes a housing 10, a cover 20 fixed to the housing 10, a light source 40 received between the housing 10 and the cover 20 and multiple clips 30 securing the housing 10 with the cover 20.

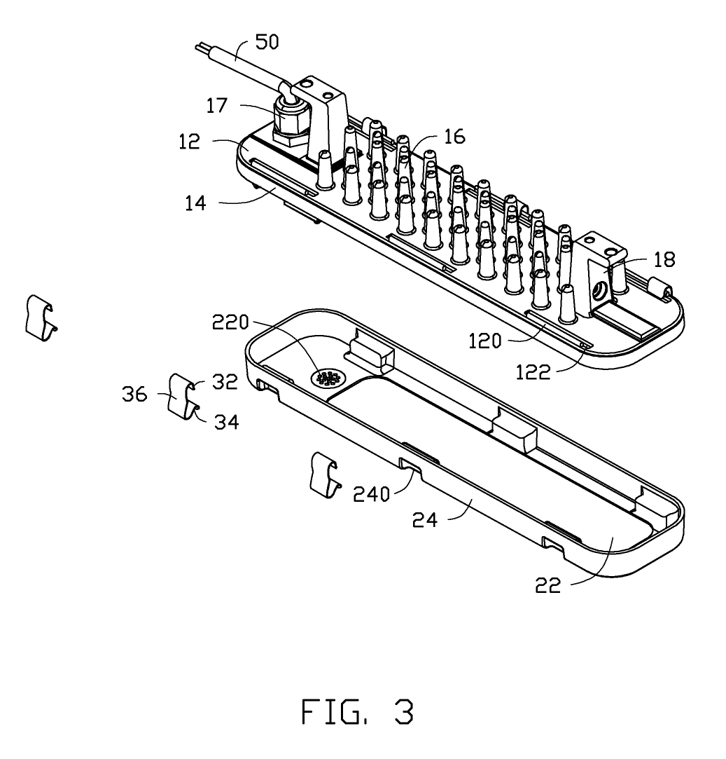

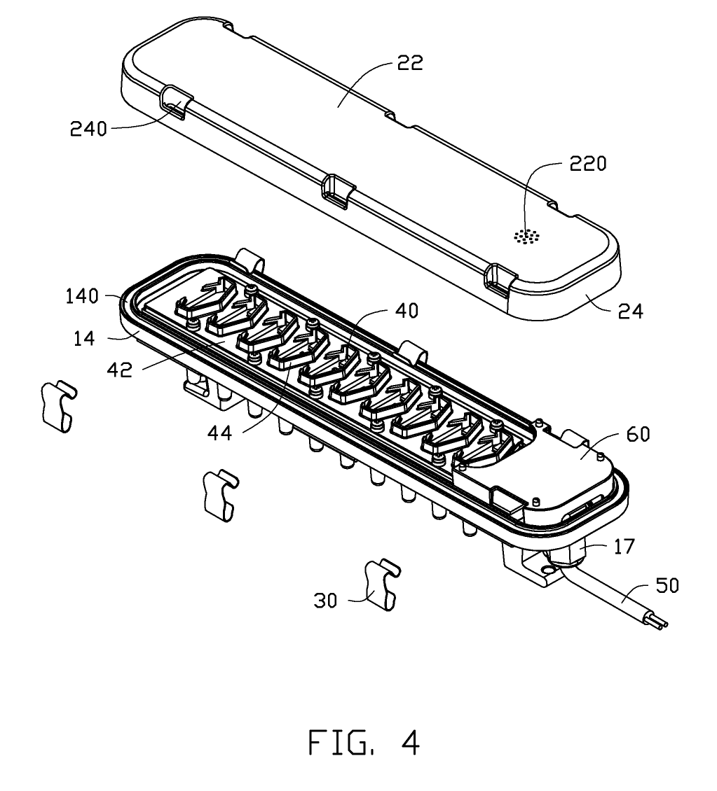

Also referring to FIG. 3, the housing 10 includes a top plate 12 and a sidewall 14 extending downwardly from a circumferential periphery of the top plate 12. The top plate 12 has a matrix of fins 16 protruding upwardly and perpendicularly from a top face thereof. Each fin 16 has a column configuration for optimizing airflow passages between the fins 16, thereby increasing heat dissipation capability of the housing 10. Two brackets 18 are formed on the top face of the top plate 12 adjacent to a left and right sides of the matrix of fins 16. The brackets 18 can attach the lamp to a supportive structure (such as a ceiling) so that the lamp could illuminate in a predetermined orientation. A port 17 is formed on the top face of the top plate 12 neighboring a right bracket 18 (FIG. 1). The port 17 is for allowing wires 50 extending therethrough into the housing 10, to thereby electrically connect the light source 40 with an outside power source (not shown). The top plate 12 has three ribs 120 formed on the top face thereof and next to each of a front and rear sides thereof. The three ribs 120 are aligned in a line parallel to the front/rear side of the top plate 120. The top plate 12 has a slot 122 defined approximate to each rib 120 in the top face thereof. The slots 122 in the same side of the top plate 12 are also arranged in a line parallel to the ribs 120. The slots 122 each have a small depth so that the slots 122 do not penetrate through the top plate 12. The sidewall 14 defines an annular groove 140 in a bottom thereof for fittingly receiving the cover 20 therein (see FIG. 4).

The light source 40 is fixed on a bottom face of the top plate 12 and surrounded by the sidewall 14. The light source 40 can be selected from an incandescent bulb, a fluorescent tube, multiple LEDs (light emitting diodes) and other suitable light sources. Preferably, the light source 40 is multiple LEDs in the present disclosure, considering a small volume of the lamp, energy saving and environmental friendliness. A printed circuit board 42 is placed between the LEDs 40 and the bottom face of the top plate 12. The printed circuit board 42 can conduct heat generated by the LEDs 40 to the top plate 12 and then dissipate the heat to an outside environment via the fins 16. A plurality of reflectors 44 are disposed on a bottom of the printed circuit board 42. Each reflector 44 partially surrounds two corresponding LEDs 40 to reflect light emitted from the LEDs 40 as a desired pattern. A power driver 60 is mounted on the bottom face of the top plate 12. The power driver 60 is located below the port 17 and electrically connected to the wires 50 and the printed circuit board 42 for inputting electrical current to the LEDs 40 from the power source through the wires 50.

The cover 20 includes a bottom plate 22 and a flange 24 extending upwardly and perpendicularly from a periphery of the bottom plate 22. The bottom plate 22 has a plurality of air passages 220 defined therein corresponding to the power driver 60, for facilitating heat dissipation of the LEDs 40 and the power driver 60. The flange 24 has three depressions 240 defined in each of a front and rear sides thereof and adjacent to the periphery of the bottom plate 24. Each depression 240 is located below a corresponding slot 122 in the top plate 12. Each depression 240 has a depth large enough to receive an end of a corresponding clip 30 therein. A top portion of the flange 24 is fittingly received in the annular groove 140 in the sidewall 14 to position the cover 20 to the housing 10.

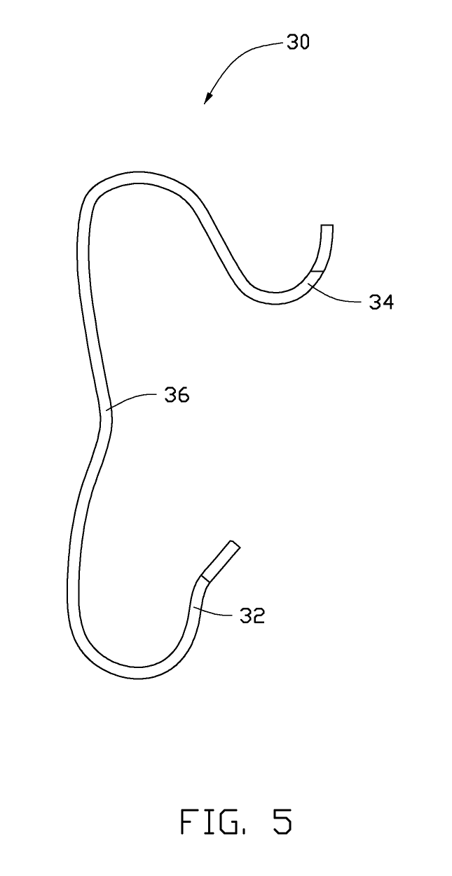

Also referring to FIG. 5, each clip 30 is made of a metal sheet bent to a desired shape. An upper portion of each clip 30 is bent downwardly to form a first pressing section 32; a lower portion of each clip 30 is bent upwardly and then downwardly to form a second pressing section 34, a middle portion of each clip 30 is bent inwardly towards the housing 10 to form a connecting section 36 interconnecting the first pressing section 32 and the second pressing section 34. In order to fix the housing 10 to the cover 20, the first pressing section 32 of each clip 30 is inserted into the slot 122 to resiliently press against the housing 10, and the second pressing section 34 of each clip 30 is received in the depression 240 to resiliently press against the cover 20. The first pressing section 32 of each clip 30 is also engaged with and confined by the rib 120 for avoiding detachment from the housing 10. As resilient deformation of the first pressing section 32 and the second pressing section 34, the connecting section 36 is urged to deform inwardly to abut against an outside circumference of the sidewall 14 of the housing 10. Therefore, the clips 30 are firmly connected to the housing 10 and the cover 20 to reliably secure them together. Furthermore, since the middle of the clip 30 is bent curvedly towards the housing 10, the stress produced by the first pressing section 32 and the second section 34 due to resilient deformation can be relieved and uniformly distributed, thereby reducing the risk that the clip 30 fractures at the middle thereof for the concentrated stress.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A lamp comprising:
a housing;
a cover attached to the housing;
a light source received between the housing and the cover; and
a clip;
wherein the clip comprises a first pressing section pressing the housing towards the cover, a second pressing section pressing the cover towards the housing, and a connecting section connecting the first pressing section with the second pressing section, the connecting section being bent curvedly towards the housing.

2. The lamp as claimed in claim 1, wherein the first pressing section of the clip is bent downwardly towards the cover.

3. The lamp as claimed in claim 1, wherein the second pressing section of the clip is bent upwardly towards the housing and then downwardly remote from the housing.

4. The lamp as claimed in claim 1, wherein the housing comprises a top plate and a sidewall extending downwardly from a periphery of the top plate, the first pressing section of the clip pressing against the top plate.

5. The lamp as claimed in claim 4, wherein the top plate has a slot defined adjacent to the periphery thereof, the first pressing section of the clip being inserted into the slot.

6. The lamp as claimed in claim 5, wherein the top plate has a rib formed between the slot and the periphery of the top plate, the first pressing section of the clip being engaged with and confined by the rib.

7. The lamp as claimed in claim 6, wherein the rib is oriented parallel to front and rear sides of the top plate.

8. The lamp as claimed in claim 4, wherein the connecting section presses against an outside circumference of the sidewall.

9. The lamp as claimed in claim 1, wherein the cover comprises a bottom plate and a flange extending upwardly from a periphery of the bottom plate, the flange having a depression to receive the second pressing section of the clip.

10. The lamp as claimed in claim 7, wherein the depression is defined adjacent to the periphery of the bottom plate.

11. The lamp as claimed in claim 1, wherein the clip is made of a bent metal sheet.

12. A lamp comprising:
a housing;
a cover detachably mounted on the housing;
a light source received between the housing and the cover; and
a resilient clip comprising an end pressing against a face of the housing and an opposite end pressing against an opposite face of the cover in a manner that the housing and the cover are sandwiched between the end and the opposite end of the resilient clip;
wherein a middle of the resilient clip is bent inwardly towards the housing.

13. The lamp as claimed in claim 12, wherein the housing comprises a top plate which defines a slot adjacent to a periphery thereof, the end of the resilient clip being inserted into the slot.

14. The lamp as claimed in claim 13, wherein the housing comprises a rib formed between the slot and the periphery of the top plate, the rib being parallel to the slot and engaging with the end of the resilient clip.

15. The lamp as claimed in claim 12, wherein the housing comprises a sidewall extending downwardly from the periphery of the top plate, the middle of the resilient clip pressing against the sidewall.

16. The lamp as claimed in claim 12, wherein the cover comprises a bottom plate and a flange extending upwardly from a periphery of the bottom plate, the flange defining a depression adjacent to the periphery of the bottom plate to receive the opposite end of the resilient clip.

17. The lamp as claimed in claim 16, wherein the resilient clip is a bent metal sheet.
